(19) United States
(12) Patent Application Publication
(10) Pub. No.: US 2024/0062664 A1
(43) Pub. Date: Feb. 22, 2024

(54) AIRCRAFT SYSTEMS AND METHODS WITH AUTOMATED RUNWAY CONDITION INFORMATION

(71) Applicant: HONEYWELL INTERNATIONAL INC., Charlotte, NC (US)

(72) Inventor: Zuowei He, Shanghai (CN)

(73) Assignee: HONEYWELL INTERNATIONAL INC., Charlotte, NC (US)

(21) Appl. No.: 17/821,027

(22) Filed: Aug. 19, 2022

(51) Int. Cl. G08G 5/02; G08G 5/00; G08G 5/06

(52) U.S. Cl. CPC G08G 5/025; G08G 5/0021; G08G 5/003; G08G 5/0047; G08G 5/065; G08G 5/0013

(57) ABSTRACT

Methods and systems are provided for assisting operation of an aircraft by automatically using a specified value contained in a message. One method involves obtaining a first set of one or more attributes associated with a runway from a first data source, obtaining status information associated with the aircraft from a second data source, obtaining, over a network, a message relevant to the runway from an external data source, analyzing the message to automatically identify a second set of one or more attributes associated with a condition of the runway, determining a location of a reference point associated with the runway based at least in part on the status information in a manner that is influenced by the second set of one or more attributes from the message, and providing, on a display device, an indication influenced by the location of the reference point.

### TECHNICAL FIELD

The subject matter described herein relates generally to aircraft systems, and more particularly, embodiments of the subject matter relate to avionics systems and methods with automated integration of runway condition information into a Runway Overrun Awareness and Alerting System (ROAAS).

### BACKGROUND

A significant number of aircraft accidents and incidents arise from runway overrun and veer-off events (collectively referred herein to as “runway excursions”). Runway excursions occur when the flight crew is unable to stop an aircraft within the available runway length due to, for example, runway contaminants such as rainwater, snow, ice, etc. This may result from an inadequate understanding of the current runway surface conditions by the flight crew. The presence of liquid contaminants (e.g., liquid water, snow, slush, ice, oil, and the like) or solid contaminants (e.g., rubber deposits from aircraft tires) on the runway surface can greatly reduce the braking friction coefficient and thus adversely affect the aircraft braking performance. For example, the rollout distance required for a commercial aircraft to reach full stop on a wet runway surface can be more than the distance required by the aircraft to stop on the same runway when dry. Providing the flight crew with prior knowledge of the current runway surface conditions prior to takeoff or landing at a runway can enable the flight crew to more appropriately maneuver the aircraft.

Hence, it is desirable to provide improved methods and systems for providing a flight crew with prior knowledge of the current runway surface conditions prior to takeoff or landing. Furthermore, other desirable features and characteristics of the present invention will become apparent from the subsequent detailed description and the appended claims, taken in conjunction with the accompanying drawings and the foregoing technical field and background.

### SUMMARY

Methods and systems are provided for assisting operation of a vehicle, such as an aircraft. One method involves obtaining a first set of one or more attributes associated with a runway from a first data source onboard the aircraft, obtaining status information associated with the aircraft from a second data source onboard the aircraft, obtaining, over a network, a message relevant to the runway from an external data source, analyzing the message to automatically identify a second set of one or more attributes associated with a condition of the runway, determining a location of a reference point associated with the runway based at least in part on the status information using the first set of one or more attributes in a manner that is influenced by the second set of one or more attributes from the message and providing, on a display device associated with the aircraft, an indication influenced by the location of the reference point.

In accordance with one or more embodiments, an aircraft system is provided that includes a display device, a communications interface to receive, from an external data source, a message relevant to a runway associated with a flight plan for an aircraft, and a controller coupled to the display device and the communications interface. The controller is configurable to obtain a first set of one or more attributes associated with the runway from a first data source onboard the aircraft, analyze the message to automatically identify a second set of one or more attributes associated with a condition of the runway, obtain status information associated with the aircraft from a second data source onboard the aircraft, determine a location of a reference point associated with the runway based at least in part on the status information using the first set of one or more attributes in a manner that is influenced by the second set of one or more attributes from the message, and provide, on the display device, an indication influenced by the location of the reference point.

In another exemplary embodiment, an apparatus is provided for at least one computer-readable medium having computer-executable instructions stored thereon. The computer-executable instructions, when executed by at least one processing system, cause the at least one processing system to obtain a first set of one or more attributes associated with a runway from a first data source onboard an aircraft, obtain status information associated with the aircraft from a second data source onboard the aircraft, obtain, over a network, a message relevant to the runway from an external data source, analyze the message to automatically identify a second set of one or more attributes associated with a condition of the runway, determine a location of a reference point associated with the runway based at least in part on the status information using the first set of one or more attributes in a manner that is influenced by the second set of one or more attributes from the message, and provide, on a display device associated with the aircraft, an indication influenced by the location of the reference point.

This summary is provided to describe select concepts in a simplified form that are further described in the detailed description. This summary is not intended to identify key or essential features of the claimed subject matter, nor is it intended to be used as an aid in determining the scope of the claimed subject matter.

### BRIEF DESCRIPTION OF THE DRAWINGS

Embodiments of the subject matter will hereinafter be described in conjunction with the following drawing figures, wherein like numerals denote like elements, and wherein:

FIG. 1 is a block diagram depicting an example flight deck system deployed onboard an aircraft, in accordance with one or more embodiments;

FIG. 2 is a block diagram depicting an example controller for use in a flight deck system, in accordance with one or more embodiments;

FIG. 3 is a block diagram depicting an exemplary message analysis service suitable for implementation by a controller in the flight deck system of FIG. 1 in accordance with one or more embodiments;

FIG. 4 is a flow diagram of a runway condition augmentation process suitable for implementation in the flight deck system of FIG. 1 in accordance with one or more exemplary embodiments; and

FIG. 5 depicts an exemplary flight deck graphical user interface (GUI) display including graphical indicia suitable for presentation on a display device in the flight deck system of FIG. 1 in accordance with one or more exemplary embodiments.

### DETAILED DESCRIPTION

The following detailed description is merely exemplary in nature and is not intended to limit the subject matter of the application and uses thereof. Furthermore, there is no intention to be bound by any theory presented in the preceding background, brief summary, or the following detailed description.

Embodiments of the subject matter described herein generally relate to systems and methods for automatically identifying one or more attributes associated with a condition of the runway by analyzing messages related to aircraft operation for determining location(s) of one or more reference points associated with a runway in a manner that is influenced by the automatically identified attribute(s). For purposes of explanation, the subject matter is primarily described herein in the context of analyzing messages relevant to a flight plan (or planned flight path) for an aircraft; however, the subject matter described herein is not necessarily limited to aircraft or avionic environments, and in alternative embodiments, may be implemented in an equivalent manner for ground operations, marine operations, or otherwise in the context of other types of vehicles with respect to a planned route of travel.

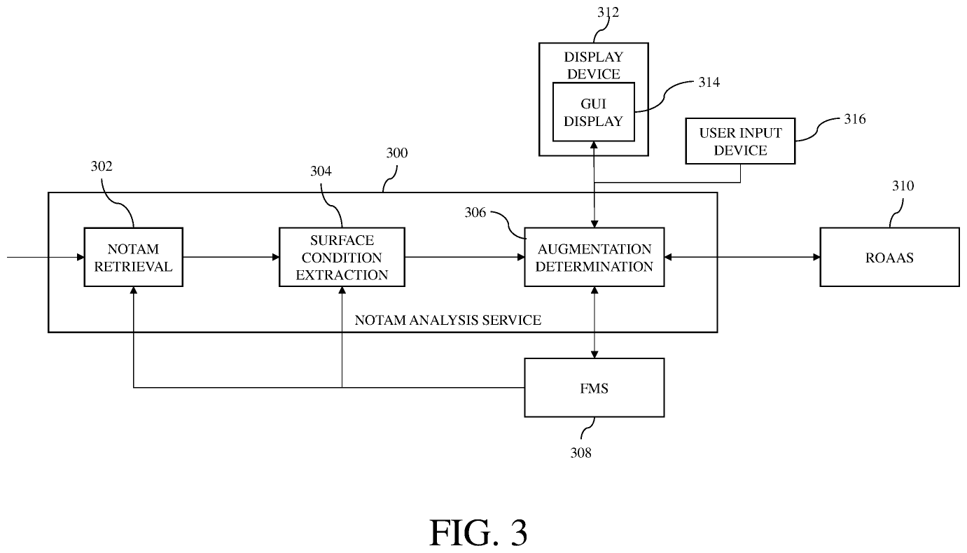

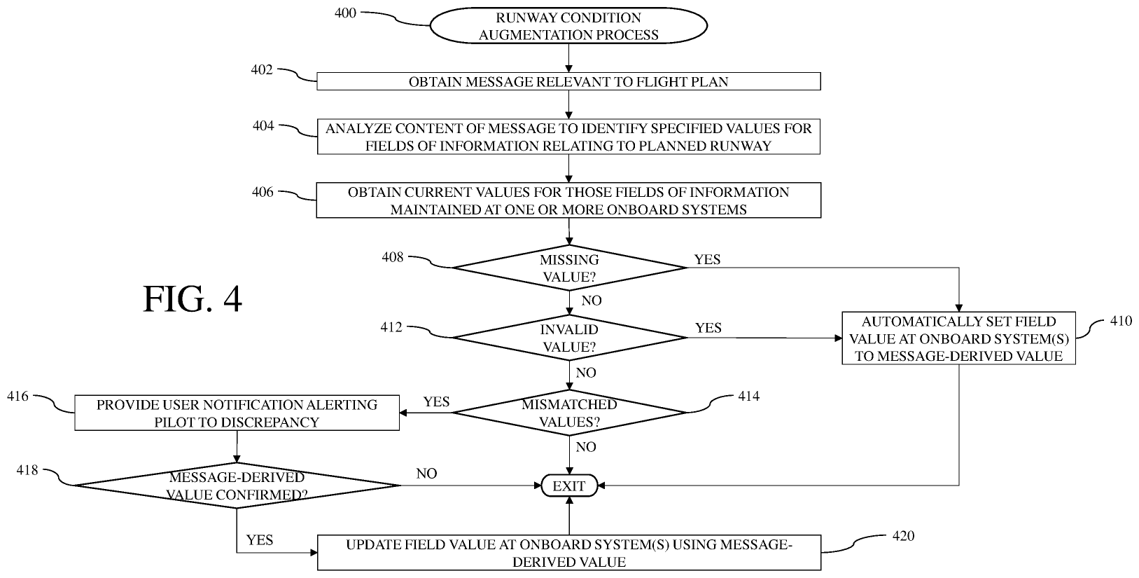

As described in greater detail below primarily in the context of FIGS. 3-4, the textual content of messages relevant to the planned flight path (or route) for an aircraft are analyzed using natural language processing (NLP), parts of speech tagging or other semantic or syntactic techniques to ascertain the intent, objective or semantic significance of a respective message and identify specified values for different fields of information contained within a respective message, and more specifically, specified values for particular attributes associated with or otherwise indicative of a surface condition of a destination runway for the aircraft according to the flight plan. Current values for the runway surface condition attributes relating to the current flight plan may be obtained from onboard systems or other data sources associated with the aircraft and compared to the specified values identified within or otherwise derived from the message(s) pertaining to the current flight plan. In one or more exemplary implementations, when a current value for a runway surface condition attribute maintained at a particular onboard system is invalid or that runway surface condition attribute is undefined at the particular onboard system, the specified value for that runway surface condition attribute may be automatically substituted for the invalid or undefined value for that runway surface condition attribute, thereby enabling algorithms, processes or other functions performed by or at that particular onboard system to utilize the specified value for that runway surface condition attribute automatically derived from a message rather than relying on an invalid or undefined value for that attribute, thereby improving the results or outcome of the particular algorithm, process or function.

In some implementations, in response to identifying a discrepancy or difference between the specified value for a particular runway surface condition attribute derived from a message and the current value for that attribute maintained at an onboard system, a user notification or alert is generated or otherwise provided to inform the pilot, co-pilot or other crew member or user of the discrepancy. In one or more implementations, after providing a user notification of a difference between the specified value derived from a message and the current value at an onboard system, the specified value may be substituted or otherwise utilized in lieu of the current value in response to receiving a user indication to utilize the specified value. For example, the user notification of the discrepancy may be provided on a graphical user interface (GUI) display in connection with a button or similar GUI element that is selectable or otherwise manipulable by the pilot or other user to provide indication of a desire to use the message-based value in lieu of the previously defined value for the particular runway surface condition attribute.

In one or more exemplary embodiments, the subject matter described herein is implemented in the context of notice to airmen (NOTAM) messages and utilizes NLP, artificial intelligence (AI) or other techniques to analyze the textual content of a particular NOTAM to derive specified values for different fields of information contained with the NOTAM. In this regard, a specified value for a particular runway surface condition field contained within a NOTAM pertaining to a destination runway of the aircraft may be more recent or more reliable than a value for that particular runway surface condition field that was previously input or otherwise defined at an onboard system. Accordingly, by incorporating specified values derived from analysis of the NOTAM in lieu of potentially stale, invalid or unavailable values, the runway analysis provided by a runway overrun awareness and alerting system (ROAAS) or other onboard system is improved, thereby improving performance, safety and reliability. Additionally, by automatically incorporating values from a NOTAM into an onboard system, a pilot or other user may be alleviated of the cognitive burden of analyzing the NOTAM content and determining how to respond, thereby reducing head-down time and maintaining situational awareness.

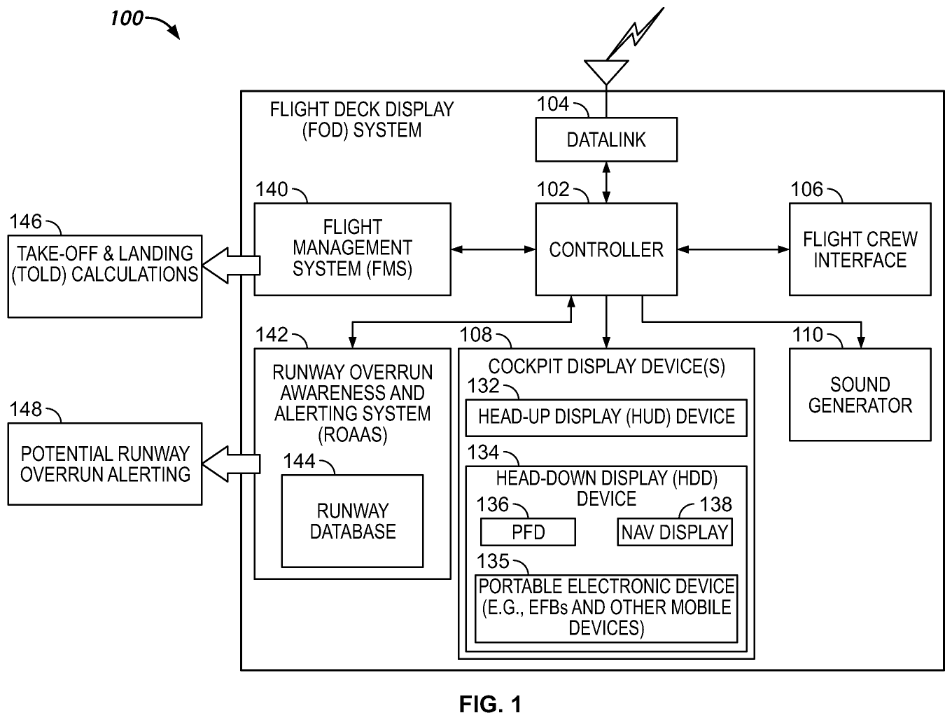

FIG. 1 is a block diagram depicting an example flight deck system 100 deployed onboard an aircraft. The example flight deck system 100 includes a controller 102, a datalink 104 communicatively coupled to an input of the controller 102, a flight crew interface 106 communicatively coupled to an input of the controller 102, one or more cockpit display devices 108 communicatively coupled to one or more outputs of the controller 102, and a sound generator 110 communicatively coupled to an output of the controller 102.

The example controller 102 obtains and processes runway condition information indicative of runway contaminants on a plurality of runway segments on one or more runways. The example controller 102 includes at least one processor and a computer-readable storage device or media encoded with programming instructions for configuring the controller. The processor may be any custom-made or commercially available processor, a central processing unit (CPU), a graphics processing unit (GPU), an application specific integrated circuit (ASIC), a field programmable gate array (FPGA), an auxiliary processor among several processors associated with the controller, a semiconductor-based microprocessor (in the form of a microchip or chip set), any combination thereof, or generally any device for executing instructions.

The computer readable storage device or media may include volatile and nonvolatile storage in read-only memory (ROM), random-access memory (RAM), and keep-alive memory (KAM), for example. KAM is a persistent or non-volatile memory that may be used to store various operating variables while the processor is powered down. The computer-readable storage device or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable programming instructions, used by the controller.

The runway condition information may be reported to the aircraft via messages sent from Air Traffic Control (ATC), airline dispatch, or the crew of another aircraft. Messages can be provided as voice broadcasts, digital Notices to Airmen (NOTAMS), Automated Terminal Information Service (ATIS) messages, and/or CPDLC (controller pilot data link messages). Additionally, the flight crew of an aircraft that has recently landed at a particular runway may report runway contaminant information regarding the runway when providing a Pilot Information Report (PIREP). The ATC may then communicate the runway contaminant information to approaching aircraft preparing to land at the runway by, for example, a Voice broadcast. This practice can help improve aircraft safety.

The runway condition information may be communicated using a Runway Condition code (RWYCC) for each of a plurality of runway segments (e.g., three segments) for a runway and may be manually entered into the controller 102 by a flight crew member utilizing a flight crew interface 106. The flight crew interface 106 can be any device or group of devices enabling a flight crew member to input data into the flight deck system 100, such as various combinations of switches, dials, buttons, keyboards, touchscreens, cursor devices, and other input devices. The flight crew may obtain the runway condition information from, for example, a voice broadcast or a digital message.

The runway condition information may be received wirelessly from a remote source via the datalink 104 in real-time. The datalink 104 can assume any form suitable for receiving wireless signals containing runway condition information from one or more remotely-located data sources. Sources from which datalink 104 may receive runway condition information include, but are not limited to, Air Traffic Control (ATC), airline dispatch, and other aircraft reporting runway condition information after using a particular runway for takeoff or landing. The runway condition information may be provided in the form of, for example, a CPDLC, a PIREP, a digital Notice to Airmen (NOTAM), and/or an Automated Terminal Information Service (ATIS) transmission.

The cockpit display devices 108 can include any image-generating device that operates in the cockpit of an aircraft that provides an airport display (e.g., a display on which images representative of an airport surface are generated, or a display superimposed over a real-world view of an airport surface as seen from the cockpit of the aircraft). The cockpit display devices 108 can include a Head-Up Display (HUD) device 132 and/or Head-Down Display (HDD) devices 134. The HUD device 132 can be, for example, a transparent or partially-transparent screen affixed to the aircraft cockpit on which graphics may be generated to effectively superimpose the graphics over the real-world view of airport surfaces. Other examples of HUD devices include pilot-worn display devices, such as helmet-mounted and near-to-eye display devices. The HDD devices 134 can include display devices that are affixed to or installed in an aircraft cockpit, as well as portable electronic devices 135 carried into the aircraft cockpit by a flight crew member (e.g., tablet computers, laptops, Electronic Flight Bags, or other mobile devices) on which an airport display is produced while the electronic device is located in the cockpit. When produced on one or more of HDD devices 134, the airport display will often assume the form of a two dimensional (2D) Airport Moving Map (AMM) generated on a navigational (NAV) display or a three dimensional (3D) AMM generated on a Primary Flight display (PFD).

A Primary Flight Display (PFD) 136 and/or a NAV display 138 can be generated on the HDD devices 134. The PFD 136 can be generated in a three dimensional (3D) format, typically from a perspective viewpoint, and may depict a 3D AMM when the aircraft is located on, above, or in close vicinity to an airport surface. The 3D AMM may thus be considered part of the PFD when the aircraft is located at an airport and the PFD displays the runways and other surfaces (e.g., taxiways) of the airport. In contrast, a NAV display 138 is generated in a two dimensional (2D) or plan format, typically from a top-down viewpoint; and depicts a 2D AMM when the Field-of-View (FOV) of NAV display 138 encompasses an airport surface due to the location of the aircraft or pilot selection of the FOV of the display. Thus, the 2D AMM may be generated as part of a NAV display when depicting an airport layout including runways, intersecting taxiways, and other runway surface features. As an example, the NAV display 138 may be an interactive navigation display (commonly referred to as an “iNAV” display), which enables a pilot to select items (e.g., a runway or waypoint) depicted on the iNAV display to summon an informational window describing certain aspects of the selected item.

The example flight deck system 100 further includes a flight management system (FMS) 140 and a runway overrun awareness and alerting system (ROAAS) 142. The FMS 140 and the ROAAS 142 are each coupled to the controller 102 for bi-directional communication therewith. While the controller 102, FMS 140, and ROAAS 142 are illustrated as distinct blocks in FIG. 1, the controller 102 in some examples may be integrated into or may be part of the FMS 140, ROAAS 142, or another aircraft system. Furthermore, the individual elements and components of flight deck system 100 can be implemented in a distributed manner using any number of physically-distinct and operatively-interconnected pieces of hardware or equipment. The lines connecting the components of flight deck system 100 denote operative connections, which can be implemented as hardwire or wireless connections utilizing known aircraft infrastructure connections. In practice, flight deck system 100 and the aircraft on which system 100 is deployed will include various other devices and components for providing additional functions and features, which are not shown in FIG. 1 and will not be described herein to avoid unnecessarily obscuring the invention.

The controller 102 may supply the runway condition information to the FMS 140 for usage in carrying-out takeoff and landing data (TOLD) calculations, and/or supply the runway condition information to the ROAAS 142 for usage in determining whether a potential runway overrun alerts (which may include but not limit to Short Runway, Landing Distance, Go Around, Max Braking, Max Reverser, etc.) should be generated. Such systems (flight management systems and runway overrun awareness and alert systems) are well-known in the avionics industry. Generally, the FMS 140 can assume any form suitable for performing TOLD calculations, while the ROAAS 142 can assume any form suitable for selectively producing potential runway overrun alerts prior to aircraft takeoff and/or aircraft landing and rollout. Furthermore, the ROAAS 142 can include a runway database 144, which contains runway lengths and possibly other information pertaining to a database of runways. In one example, the ROAAS 142 is a SMARTRUNWAY® and/or a SMARTLANDING® system developed and commercially marked by the assignee of the present application, Honeywell International Inc., currently headquartered in Morristown, N.J.

During operation, the flight deck system 100 receives runway condition information pertaining to a runway approached for use (e.g., a runway approached by the aircraft for purposes of takeoff, landing, or traversal) by the aircraft on which the flight deck system 100 resides. The runway condition information describes the condition of a plurality of different segments of the runway (e.g., three different segments, such as a touchdown, midpoint, and rollout portion of a runway during a landing). The example flight deck system 100 can utilize this runway condition information in a number of manners. The flight deck system 100 can forward this runway condition information to (i) the FMS 140 for usage in performing TOLD calculations (e.g., TOLD calculation module 146) and/or to (ii) the ROAAS 142 for usage in determining when to generate potential runway overrun alerts (e.g., potential runway overrun alerting module 148). Additionally, or alternatively, the example flight deck system 100 can selectively display the runway condition information on a 3D AMM produced on a PFD and/or on 2D AMM produced on a NAV display.

The example controller 102 can command the sound generator 110 to produce a verbal message describing the runway condition information of a runway or runway segment in conjunction with generation of a runway condition graphic. Alternatively, the controller 102 may command sound generator 110 to generate a verbal message or aural alert describing the runway condition information of a runway or runway segment only under selected conditions, such as when the runway condition information indicates that a runway or runway segment may cause extreme difficulty braking. In this latter case, the controller 102 may command the sound generator 110 to generate an audible alert or cautionary message prior to usage of the runway surface by the aircraft, such as “CAUTION: POOR BRAKING CONDITIONS ON RUNWAY.”

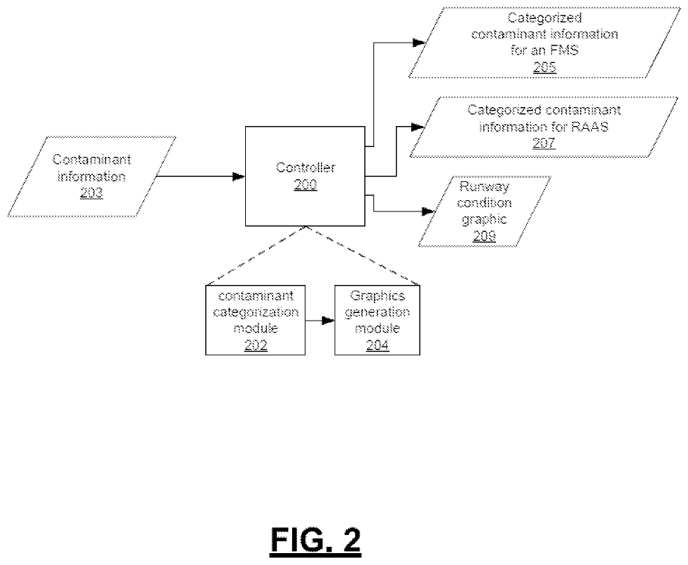

FIG. 2 is a block diagram depicting an example controller 200 for use in a flight deck system. The example controller 200 includes one or more processors configured by programming instruction on non-transient computer readable media to implement a contaminant categorization module 202 and a graphics generation module 204.

The example contaminant categorization module 202 is configured to retrieve contaminant information 203 regarding a runway approached for use, wherein the retrieved contaminant information 203 describes the contaminant condition for each of a plurality of segments of the runway (e.g., three segments, such as touchdown, midpoint, and rollout), and categorize the contaminant condition of each of the plurality of (e.g., at least three) different segments of the runway. The example contaminant categorization module 202 is configured to categorize the contaminant condition of each of the plurality of (e.g., at least three) different segments of the runway based on the received contaminant information 203 for each of the plurality of (e.g., at least three) different contiguous segments of the runway.

The example contaminant categorization module 202 may be configured to receive the runway contaminant information 203 over a datalink. The runway contaminant information 203 may be communicated in the form of a runway condition code (RWYCC) for each of the plurality of (e.g., at least three) different contiguous segments of the runway. The runway contaminant information 203 received over a datalink may include CPDLC (controller pilot data link communication), NOTAM (notice to airmen) data, data received from ATC, and/or data received from a leading aircraft that landed at the runway. The example contaminant categorization module 202 may be further configured to transmit the contaminant condition categories for each of the at least three different segments of the runway to a trailing aircraft.

The example contaminant categorization module 202 is further configured to provide categorized contaminant information 205 to an FMS for TOLD calculations and/or categorized contaminant information 207 to a ROAAS for generation of a potential runway overrun alert when one exists. This can allow the FMS, when performing take-off and landing calculations for the runway, to separately calculate a required landing distance for each of the plurality of runway segments. For example, the FMS may calculate a landing distance for a first segment (e.g., touchdown portion) of the runway using the categorized contaminant information 203 for the first segment, calculate a required landing distance for the second segment (e.g., midpoint portion) of the runway using the categorized contaminant information 203 for the second segment, and calculate a required landing distance for the third segment (e.g., rollout portion) of the runway using the categorized contaminant condition for the third segment. This may also allow the ROAAS to calculate whether a potential runway overrun alert should be generated taking into account the categorized contaminant information 203 for each of the plurality of (e.g., at least three) different contiguous segments of the runway.

The example graphics generation module 204 is configured to generate a runway condition graphic 209 having at least three different segments to be overlaid over or positioned adjacent to a depiction of the runway on an airport display. Each segment of the runway condition graphic 209 is associated with a different segment of at least three different contiguous segments of the runway and configured to provide a graphical indication of the contaminant condition for the associated segment of the runway. The example graphics generation module 204 is configured to visually code each segment of the runway condition graphic 209 in a manner that is representative of the contaminant condition category for its associated segment of the runway and cause the generated runway condition graphic 209 to be overlaid over or positioned adjacent to the depiction of the runway on the airport display. To visually code each segment of the runway condition graphic 209 in a manner that may be representative of the contaminant condition category for its associated segment of the runway, the example graphics generation module 204 may be configured to color code each segment of the runway condition graphic 209 in a color that is representative of the contaminant condition category for its associated segment of the runway. Each segment of the runway condition graphic 209 may include a text annunciation graphic comprising annunciation graphics configured to describe the contaminant condition of its associated segment of the runway. The example graphics generation module 204 may be configured to selectively generate the text annunciation graphic on the airport display in response to flight crew selection of runway condition information received via a flight crew interface.

The airport display may be a three dimensional (3-D) Airport Moving Map (AMM) produced on a primary flight display, and the example graphics generation module 204 may be configured to selectively cause the runway condition graphic 209 to be overlaid over or positioned adjacent to the depiction of the runway on the AMM. The airport display may be a two dimensional AMM, and the runway condition graphic 209 may include a symbol for use with each segment of the runway. In this example, the example graphics generation module 204 may be configured to cause the symbols of the runway condition graphic 209 to be displayed adjacent to the depiction of the associated segment of the runway on the AMM.

The example controller 200 may be further configured to transmit the calculated required landing distance for each of the plurality of segments to a trailing aircraft that has approached the runway for use. For example, the example controller 102 may transmit the calculated required landing distance for the first segment (e.g., touchdown portion) of the runway, the second segment (e.g., midpoint portion) of the runway, and the third segment (e.g., rollout portion) of the runway to a trailing aircraft that has approached the runway for use.

A flight deck system that implements the example controller 102 or 200 can notify the flight crew of the real-time runway contaminant information obtained via datalink 104 (or entered via flight crew interface 106). The runway contaminant information may be visually conveyed as a runway condition graphic displayed on a PFD 136 or a NAV display 138. The runway condition graphic may be “selectively” displayed, that is, displayed only at selected times or in response to flight crew selection data received via flight crew interface 106. When displayed, the runway condition graphic can be presented in any manner that can be intuitively and rapidly comprehended by a pilot when glancing at the display. For example, the runway condition graphic can be displayed as text, as symbology, or a combination thereof. To quickly relate the runway contaminant status to the flight crew, the runway condition graphic may be categorized, that is, assigned to one of a number of categories or classifications representing different classes of runway contaminant conditions.

As described in U.S. Patent Publication No. 2021/0221531, in one or more implementations the runway surface condition can be categorized or classified into one of seven different categories or codes ranging a best performing surface condition code of six (6), where the respective runway segment is dry, to a worst performing surface condition code of zero (0), where the respective runway segment contains wet ice, slush over snow, water over compacted snow, and or dry snow or wet snow over ice.

As described in U.S. Patent Publication No. 2021/0221531, a flight deck system that implements the example controller 102 or 200 may be configurable to generate or otherwise provide various different runway condition graphics that include graphical indicia of the runway surface conditions associated with different segments of a runway (e.g., by color coding different segments according to their runway condition code or surface contaminant). In this regard, in exemplary implementations, the FMS 140 and/or the ROAAS 142 divides the destination runway for the aircraft according to the flight plan maintained by the FMS 140 into different segments defined by different reference points that delineate the location of the transition from one segment to the next. For example, a runway may be divided into three segments (touchdown, midpoint and rollout). The controller 102, 200 may visually code each segment of the runway condition graphic in a manner that provides graphical indication of the contaminant condition category for its associated segment of the runway. The generated runway condition graphic may then be overlaid over or positioned adjacent to the depiction of the runway on an airport display, such as a two dimensional Airport Moving Map (AMM) produced on a navigation display, a three dimensional Airport Moving Map (AMM) produced on a primary flight display, or the like.

In exemplary embodiments, the FMS 140 and/or the ROAAS 142 calculates the relative locations of the reference points that delineate the transitions between segments along with landing parameters for the respective segments based on the current energy state of the aircraft (e.g., based on status information associated with the aircraft obtained from onboard data sources) and the runway surface conditions associated with the respective segments. In this regard, the FMS 140 and/or the ROAAS 142 may calculate a required runway length for the aircraft by calculating a first landing distance associated with an initial runway segment (e.g., the touchdown segment) of the runway based on the surface condition or contaminant associated with that respective segment, calculating a second landing distance for a second runway segment (e.g., midpoint segment) based on the surface condition or contaminant associated with that respective segment, calculating a third landing distance for a third runway segment (e.g., rollout segment) based on the surface condition or contaminant associated with that respective segment, and then adding the respective distances associated with the respective runway segments to arrive at a required runway length for the aircraft. When the required runway length is less than the available runway length for the destination runway, the ROAAS 142 generates or otherwise provides one or more alerts or other user notifications to alert the pilot or other members of the flight crew.

FIG. 3 depicts an exemplary embodiment of a message analysis service 300 suitable for use in the flight deck system 100 of FIG. 1. In this regard, in one or more embodiments, the message analysis service 300 may be implemented by or at the controller 102, for example, by a processor associated with the controller 102 executing computer-executable programming instructions stored on a computer-readable medium associated with the controller 102 that, when executed, cause the processor of the controller 102 to generate or otherwise provide the message analysis service 300. That said, in other implementations, the message analysis service 300 may be implemented by or at the FMS 140, the ROAAS 142, or another onboard system, or components or aspects of the message analysis service 300 may be implemented in a distributed manner across one or more of the controller 102, the FMS 140 and/or the ROAAS 142. In this regard, it should be noted that FIG. 3 depicts a simplified representation of the message analysis service 300 for purposes of explanation and is not intended to be limiting.

In exemplary embodiments, the message analysis service 300 is configured to analyze messages received via a communications system onboard an aircraft (e.g., such as datalink 104), automatically identify one or more specified values for one or more attributes associated with a condition of the runway contained within a respective message, and automatically augment or otherwise modify the value(s) for the attribute(s) maintained at one or more onboard systems 308, 310, which, in turn determine one or more respective locations of one or more reference points associated with the runway in a manner that is influenced by the specified value(s) for the attribute(s) derived from the message. For example, the specified value(s) for a particular runway surface condition attribute contained within a message may be utilized by a runway overrun awareness and alerting system (ROAAS) 310 (e.g., ROAAS 142) to determine respective landing distances or stopping distances for one or more runway segments to determine a corresponding location of a stopping point or exit point along the runway where the expected speed of the aircraft is expected to be less than a threshold value for exiting the runway and beginning taxiing and provide a corresponding alert, user notification, or other indication when the calculated location of the exit point exceeds the available runway length (e.g., potential runway overrun alerting module 148), as described in greater detail below. Similarly, the specified value(s) for a particular runway surface condition attribute contained within a message may be utilized by TOLD algorithms or functions (e.g., TOLD calculation module 146) performed by an FMS 308 (e.g., FMS 140).

In exemplary embodiments, the message analysis service 300 is configured to analyze NOTAMs, and accordingly, the message analysis service 300 may alternatively be referred to herein as a NOTAM analysis service. That said, it should be appreciated the subject matter described herein is not limited to NOTAMs and may be implemented in an equivalent manner for any type of message capable of including textual content containing runway condition codes or otherwise specifying values for runway surface condition attributes.

In one or more exemplary implementations, a NOTAM analysis service 300 includes a NOTAM retrieval service 302 that is configured to retrieve a subset of NOTAMs (e.g., from a remote system) that are relevant to the current flight plan. In this regard, the NOTAM retrieval service 302 may utilize the waypoints, airspaces, airports, GPS coordinates and the like associated with the flight plan and/or the current aircraft state to search or query the remote system for NOTAMs that are likely to be relevant to the current flight plan and the destination airport and effectively filter or exclude, from further consideration, any NOTAMs that are not relevant to the waypoints, airspaces, runways, airports or other aspects of the current flight plan. After retrieving the subset of NOTAMs for analysis, the NOTAM retrieval service 302 may further preprocess the NOTAMs by expanding acronyms and translating the NOTAMs into a common uniform format to standardize the input to NLP models, AI models or other downstream services that analyze the NOTAMs.

The obtained subset of NOTAMs relevant to the current flight plan are input or otherwise provided to an surface condition extraction service 304 that is configured to utilize NLP, parts of speech tagging or other semantic or syntactic AI techniques to analyze the textual content of a respective NOTAM to identify the different fields of information contained within the respective NOTAM, the specified values for those fields of information, and the intent, objective or semantic significance of a respective NOTAM. In exemplary embodiments described herein, the surface condition extraction service 304 retrieves or otherwise obtains, from the FMS 308 or another onboard system, current flight plan information that includes indication of the currently planned or assigned runway for landing at the currently planned destination airport, and then analyzes the respective NOTAMs to detect or otherwise identify when a NOTAM includes specified values for fields of information corresponding to the surface condition of the currently planned or assigned runway at the destination airport. When the surface condition extraction service 304 identifies a NOTAM including runway surface condition information for the current runway, the surface condition extraction service 304 may output or otherwise provide a structured data record or entry that includes the textual content of the respective NOTAM along with the metadata tags identifying the extracted specified values for the different fields of runway surface condition attributes contained within the respective NOTAM.

For example, the surface condition extraction service 304 may parse or otherwise analyze the textual content of a NOTAM to extract or otherwise identify the operational subject of the NOTAM as pertaining to the current runway (e.g., based on a runway identifier or the like contained within the NOTAM), and based thereon, identify any specified restrictions, instructions, conditions or other status associated with the runway. For example, for a NOTAM with the textual content “SLC RWY 34L FICON 3/5/2 50 PRCT WET AND 50 PRCT ⅛ IN WET SN OVER COMPACTED SN, 50 PRCT WET AND 25 PRCT ⅛ IN WET SN OVER COMPACTED SN, 10 PRCT ¼ IN SLUSH OVER ICE AND 75 PRCT ¼ IN SLUSH OBSERVED AT 1703251855 1703251900-1703261900,” the surface condition extraction service 304 may parse and analyze the text of the NOTAM to identify runway 34L as the operational subject of the NOTAM with specified field conditions including runway codes 3, 5 and 2 for the touchdown, midpoint, and rollout runway segments respectively, with corresponding surface contaminants of 50% Wet and 50% ⅛ in Wet Snow over compacted Snow, 50% Wet and 25% ⅛ in Wet Snow over Compacted Snow, and 10% ¼ in Slush over Ice and 75% ¼ Slush, respectively. Thus, when runway 34L is configured as the currently planned or assigned runway for the aircraft indicated by the flight plan at the FMS 308, the surface condition extraction service 304 may output or otherwise provide a structured data record or entry that indicates the specified runway condition code values and/or surface contaminant compositions for the respective segments of the runway (e.g., RWYCC=3 for a touchdown segment surface condition attribute, RWYCC=5 for a midpoint segment surface condition attribute and RWYCC=2 for a rollout segment surface condition attribute). In a similar manner, when a NOTAM identifies a particular runway status as being closed (in whole or in part) or subject to other conditions or restrictions that limit the availability or the available length of the runway, the surface condition extraction service 304 may output or otherwise provide corresponding indicia of the status of the runway derived from the NOTAM.

Still referring to FIG. 3, the set of specified values for runway surface condition attributes pertaining to the current destination runway that were extracted from the NOTAM are output or otherwise provided to an augmentation determination service 306 that is configured to compare or otherwise analyze the specified values for the runway surface condition attributes from the NOTAM to the current values for the runway surface condition attributes for the current destination runway maintained at the FMS 308 (or another onboard system). For example, the FMS 308 may include existing values for the runway surface condition attributes, the available runway length, and/or the like that were previously input or otherwise defined by the pilot or other user in connection with the flight plan or other flight planning tasks prior to receipt of the NOTAM. That said, in other scenarios, values for different runway attributes may be nonexistent or missing, or the values maintained at the FMS 308 or other onboard system may be invalid, stale or otherwise pertain to another runway that is no longer selected or assigned for landing.

As described in greater detail below, the augmentation determination service 306 compares the specified values for the runway attributes from the NOTAM to the current values maintained at the FMS 308 or other onboard system to determine whether and how to utilize the specified values derived from the NOTAM, for example, by automatically substituting a specified value from the NOTAM for an existing value or a missing value, automatically augmenting an existing value using a specified value from the NOTAM (e.g., by a weighted combination of values), or prompting a user for manual verification or confirmation of what value to utilize. In this regard, the augmentation determination service 306 is coupled to a display device 312 (e.g., display device 108) to generate or otherwise provide one or more user notifications or alerts on a GUI display 314 when there is a mismatch or discrepancy a specified value for a runway attribute from a NOTAM and the current value for that runway attribute maintained at the FMS 308, the ROAAS 310, or another onboard system. As described below, the user notification may include or otherwise be provided in concert with a button or similar selectable GUI element that is manipulable by a pilot or other user via a user input device 316 associated with the display device 312 to provide a corresponding indication of what value to utilize back to the augmentation determination service 306. In this regard, the display device 312 may be realized as any sort of electronic display capable of graphically displaying flight information or other data associated with operation of the aircraft, and the user input device 316 may be realized as any sort of device configured to allow a user (e.g., a pilot, co-pilot, or crew member) to interact with the GUI display 314 depicted on the display device 312 and/or other elements of a flight deck system, such as, for example, a keypad, touchpad, keyboard, mouse, touch panel (or touchscreen), joystick, knob, line select key, an audio input device (e.g., a microphone, audio transducer, audio sensor, or the like) or another suitable device adapted to receive input from a user.

When the augmentation determination service 306 determines a specified value for a runway attribute should be substituted or otherwise utilized to augment an existing value for that runway attribute, the augmentation determination service 306 may provide a command, instruction or other signal to the appropriate onboard systems 308, 310 that indicates the specified or augmented value for the particular runway attribute to be utilized or otherwise implemented at the respective onboard system 308, 310 (e.g., by the TOLD calculation module 146 and/or the potential runway overrun alerting module 148) in lieu of any previous value for that particular runway attribute. In this manner, the resulting outputs or other algorithms or functionality implemented at the respective onboard systems 308, 310 are influenced by the specified runway attribute value(s) derived from the NOTAM pertaining to the current destination runway.

FIG. 4 depicts an exemplary embodiment of a runway condition augmentation process 400 suitable for implementation in connection with a flight deck system or other aircraft system (e.g., by a controller 102 implementing the NOTAM analysis service 300) to analyze messages related to aircraft operation to extract runway surface condition information and augment runway surface condition information at one or more onboard systems using the message-derived runway surface condition information to influence the algorithms, functions or other calculations and corresponding output generated by the onboard system(s). The various tasks performed in connection with the runway condition augmentation process 400 may be implemented using hardware, firmware, software executed by processing circuitry, or any combination thereof. For illustrative purposes, the following description may refer to elements mentioned above in connection with FIGS. 1-3. In practice, portions of the runway condition augmentation process 400 may be performed by different elements of an aircraft system; however, for purposes of explanation, the runway condition augmentation process 400 may be described herein primarily in the context of being implemented by the NOTAM analysis service 300 executed by the controller 102 in the flight deck system 100. It should be appreciated that the runway condition augmentation process 400 may include any number of additional or alternative tasks, the tasks need not be performed in the illustrated order and/or the tasks may be performed concurrently, and/or the runway condition augmentation process 400 may be incorporated into a more comprehensive procedure or process having additional functionality not described in detail herein. Moreover, one or more of the tasks shown and described in the context of FIG. 4 could be omitted from a practical embodiment of the runway condition augmentation process 400 as long as the intended overall functionality remains intact.

The runway condition augmentation process 400 initializes or otherwise begins by receiving or otherwise obtaining a message relevant to a flight plan of an aircraft and analyzing the content of the message to automatically identify specified values for one or more fields of information relating to a planned runway associated with the flight plan (e.g., tasks 402, 404). For example, as described above, a NOTAM analysis service 300 at the controller 102 may include or otherwise support a NOTAM retrieval service 302 capable of using the current flight plan information maintained at the FMS 140, 308 to retrieve, over a communications network via datalink 104 or another communications system onboard the aircraft, one or more NOTAMs related to the current flight plan from a remote system (e.g., a NOTAM database maintained by the FAA in the United States) using one or more waypoints, airspaces, airports, GPS coordinates or the like as an input query or search key. For each retrieved NOTAM relevant to the current flight plan, a surface condition extraction service 304 associated with the NOTAM analysis service 300 may analyze the textual content of the NOTAM to identify or otherwise determine whether the content of the NOTAM includes specified values for one or more attributes of the condition or status of the planned runway associated with the flight plan. In this regard, in some implementations, a NOTAM may directly specify values for the runway condition or status, for example, when the runway is the operational subject of the respective NOTAM. In other implementations, a NOTAM may indirectly specify or infer values for the runway condition or status, for example, by characterizing the weather associated with an airspace encompassing the runway or a waypoint in proximity to the airport where the runway is located. As described above, the specified values for the fields of information related to the runway condition may include, but are not limited to, runway condition codes associated with one or more segments of the runway, identification of the type of surface contaminant associated with one or more segments of the runway, the amount, percentage or other quantitative characterization of the coverage of a surface contaminant, identification and/or quantitative characterization of meteorological conditions at or in the vicinity of the airport, the available runway length or other operational status of the runway and/or the like.

After identifying specified values for one or more fields of information relating to a planned runway associated with the flight plan, the runway condition augmentation process 400 continues by retrieving or otherwise obtaining the corresponding values for the field(s) of information relating to the planned runway that are currently maintained at one or more onboard systems (task 406). As described above, in response to receiving indicia of a set of specified values for runway condition attributes in a NOTAM from the surface condition extraction service 304, the augmentation determination service 306 of the NOTAM analysis service 300 retrieves or otherwise obtains the corresponding values currently maintained for those runway condition attributes maintained at the FMS 308 and/or the ROAAS 310 for analysis to determine whether the specified values from the NOTAM match or otherwise align with the current values at the FMS 308 and/or the ROAAS 310.

When a corresponding value for a field of information relating to the planned runway is missing or otherwise does not exist at the onboard system(s), the runway condition augmentation process 400 automatically sets the field value at the onboard system(s) to be equal to the specified value derived from the message (tasks 408, 410). In this regard, if a pilot or other user has failed to enter a value for a particular runway attribute and a specified value exists for that runway attribute in a NOTAM, the NOTAM analysis service 300 may automatically instruct or otherwise configure the FMS 308 and/or the ROAAS 310 to utilize the specified value derived from the NOTAM, thereby improving the accuracy and reliability of the outputs generated by the TOLD calculation module 146 and/or the potential runway overrun alerting module 148. For example, if the pilot or other user has been unable to enter or otherwise define the runway surface condition attributes for the destination runway (e.g., due to the ATC reassigning the aircraft to a different runway during flight), a runway condition code or other specified value for the runway surface condition of one or more segments of the runway may be imported from the NOTAM to the ROAAS 310, thereby allowing the ROAAS 310 to utilize the specified values for the runway surface condition of one or more segments of the runway when calculating or otherwise determining the required landing distance for the aircraft and the corresponding locations for the stopping point or exit point and other potential reference points along the runway, such that the resulting values and corresponding graphical indicia or alerts are influenced by the specified value(s) derived from the NOTAM.

In exemplary embodiments, the runway condition augmentation process 400 identifies or otherwise determines whether the corresponding value for a field of information relating to the planned runway at the onboard system(s) is invalid and automatically sets the field value at the onboard system(s) to be equal to the specified value derived from the message when the currently maintained value at the onboard system(s) is invalid (tasks 412, 410). For example, when the ATC reassigns the aircraft to a different runway or the destination runway is otherwise changed during flight, the pilot or other user may fail to update values for the runway condition to reflect the currently destination runway. In this example, the ROAAS automatically determines the runway that the aircraft is currently flying towards (e.g., based on calculations using the current, real-time aircraft location, heading, and the like) and detects or otherwise identifies when the runway that the aircraft is currently flying en route to does not match a previously planned destination runway. In this regard, in some implementations, the NOTAM analysis service 300 may detect or otherwise identify when the current values for runway attributes maintained at the FMS 308 and/or the ROAAS 310 are invalid, and in response, automatically substitute values derived from the NOTAM for any invalid values at the FMS 308 and/or the ROAAS 310.

Still referring to FIG. 4, in exemplary embodiments, the runway condition augmentation process 400 compares the currently maintained values for the runway condition field(s) at the onboard system(s) to the specified values derived from the message to detect or otherwise identify when a mismatch or other discrepancy exists between the message-derived value and the currently maintained value at the onboard system (task 414). When a mismatch exists, the runway condition augmentation process 400 generates or otherwise provides a user notification that alerts a pilot or other user to the existence of a discrepancy or mismatch between the currently maintained values at an onboard system and the specified values provided in a message relating to the planned runway (task 416). For example, when the ROAAS 310 currently maintains a runway condition code value for a particular segment of the destination runway that indicates a dry condition of the runway lacking any surface contaminant and a recent NOTAM specifies a different runway condition code value that indicates presence of a surface contaminant that would degrade landing performance on the runway, the NOTAM analysis service 300 may generate or otherwise provide a graphical user notification on a GUI display 314 on a display device 312 to alert the pilot or other user of the discrepancy. In addition to a graphical user notification, in some embodiments, the NOTAM analysis service 300 may also provide aural or auditory alerts or other alerts (e.g., haptic alerts, or the like) to notify the pilot of the discrepancy.

In response to receiving indication from a user that verifies or otherwise confirms that the message-derived value for a particular runway condition field should be utilized, the runway condition augmentation process 400 updates the value for that particular runway condition field at the onboard system(s) using the message-derived value (tasks 418, 420). In one or more exemplary embodiments, the runway condition augmentation process 400 generates or otherwise provides a button or similar selectable GUI element in concert with the user notification that allows the pilot or other user to verify or otherwise confirm whether the NOTAM-derived value should be utilized in lieu of the currently maintained value that was previously input by the pilot or otherwise previously configured for the runway. In response to receiving user selection of the GUI element via the user input device 316, the NOTAM analysis service 300 instructs or otherwise configures the FMS 308 and/or the ROAAS 310 to utilize the specified value derived from the NOTAM.

In some embodiments, in response to receiving user confirmation to use a NOTAM-derived value, the NOTAM analysis service 300 instructs or otherwise configures the FMS 308 and/or the ROAAS 310 to substitute the specified value derived from the NOTAM for the value that was previously input or previously configured for that runway condition attribute. In other embodiments, the NOTAM analysis service 300 may augment or otherwise combine the previously input or previously configured value for that runway condition attribute using the specified value to arrive at an augmented value for that runway condition attribute that reflects the previous value but is influenced by the specified value for that runway condition attribute derived from the NOTAM. For example, the user notification generated by the NOTAM analysis service 300 may include one or more GUI elements that allow the pilot or other user to specify how the pilot would like to utilize the NOTAM-derived value, for example, by averaging a NOTAM-derived value with a previously-configured value. In this regard, some implementations may allow the pilot to define or otherwise assign different relative weights to be assigned to the NOTAM-derived value and the previously-configured value to achieve an augmented value that weights the different values in accordance with the pilot's preferences or the pilot's degree of confidence in the different values (or the respective sources thereof).

Referring again to FIGS. 1-3 with continued reference to FIG. 4, by virtue of the runway condition augmentation process 400, the accuracy and reliability of the outputs generated by the TOLD calculation module 146, the potential runway overrun alerting module 148, and other algorithms or functions provided by the FMS 140, 308 and/or the ROAAS 142, 310 may be improved by incorporating more recent or more accurate runway condition information derived from a NOTAM. For example, in practice, runway surface condition information may be unavailable (e.g., when a pilot lacks knowledge of the condition or is otherwise unable to input the information to the FMS 140, 308 and/or the ROAAS 142, 310 due to workload, human error, or the like), invalid (e.g., when ATC issues a late runway reassignment and the pilot is not able to update the FMS 140, 308 and/or the ROAAS 142, 310), stale or outdated (e.g., due to changes to meteorological conditions at the airport after the pilot has input the runway surface condition information), or otherwise inaccurate (e.g., when the pilot inadvertently inputs incorrect values). In this regard, the NOTAM-derived runway surface condition attributes may augment or otherwise supplement the currently configured values at the FMS 140, 308 and/or the ROAAS 142, 310, for example, by substituting NOTAM-derived values for runway surface condition attributes for inaccurate, invalid or missing values, resulting in the outputs generated by the FMS 140, 308 and/or the ROAAS 142, 310 being influenced by the NOTAM-derived values. When the NOTAM-derived values do not match the currently configured values at the FMS 140, 308 and/or the ROAAS 142, 310 or otherwise maintained for the runway in a runway database 144, the runway condition augmentation process 400 may output or otherwise provide one or more user notifications to the pilot to verify or otherwise confirm whether the currently configured values are accurate to mitigate potential issues with respect to the currently configured values and allow the FMS 140, 308 and/or the ROAAS 142, 310 to utilize the NOTAM-derived values to improve subsequent computations.

For example, in one or more implementations, NOTAM-derived values for runway surface conditions, temporary reductions in available runway length and other runway attributes may be utilized by a ROAAS 142, 310 when calculating landing distances and corresponding locations of reference points along the runway based on the current aircraft state to provide corresponding runway alerts or other runway condition graphics. In this regard, the ROAAS 142, 310 may receive or otherwise obtain status information indicative of the current aircraft energy state from one or more onboard systems, such as, for example, the current altitude of the aircraft, the current speed of the aircraft, the current location of the aircraft, the current aircraft heading, the current aircraft flight path angle or descent rate, the current drag configuration of the aircraft, the current amount of fuel remaining onboard the aircraft, and/or the like. Based on the current aircraft energy state and the distance between the current aircraft altitude and location and the altitude and location associated with the runway, the ROAAS 142, 310 may calculate or otherwise determine the expected altitude and speed of the aircraft upon reaching the runway threshold, the expected location of the touchdown point on the runway, the expected location where the aircraft transition to the deceleration phase, and the expected location of the exit point at the end of the deceleration phase at which point the aircraft can rollout to taxi. The respective locations of the touchdown point, the deceleration phase transition and the exit point are calculated by the ROAAS 142, 310 and/or the potential runway overrun alerting module 148 based on the expected aircraft speed and other energy state parameters at touchdown and braking performance capability of the aircraft as influenced by the runway surface condition(s) along the corresponding segment(s) of the runway where the respective transition and deceleration phases are expected to be performed before reaching the exit point. In this regard, the runway condition code associated with a respective segment of the runway may be utilized to scale or otherwise adjust the braking friction coefficient associated with the aircraft decelerating along that segment, thereby influencing the resulting deceleration rate for that segment and corresponding distance required to reduce the speed of the aircraft from the estimated speed at the start of the respective segment to a threshold speed or otherwise slow the aircraft to a stop. Thus, the NOTAM-derived values for the runway surface condition attributes, the available runway length and/or other runway condition attributes influence the respective locations determined for the exit point, the deceleration phase transition point, and/or the like, which, in turn, influence the potential runway overrun alerts or other runway condition graphics (e.g., when the required landing and stopping distances due to the runway surface conditions result in the location of the runway exit point extends beyond the available runway length). In some implementations, when the NOTAM-derived values include coverage percentages or other surface contaminant details, the resulting locations and distances calculated by the ROAAS 142, 310 and/or the potential runway overrun alerting module 148 may be further refined to reflect the particular surface contaminant at issue and the relative coverage thereof.

It should be noted that in practice, there are numerous different techniques or strategies for calculating or otherwise estimating required landing distances based on different runway surface conditions, which may be recommended by regulatory organizations or set forth in industry standard or authorities publications, such as, for example, European Organisation for Civil Aviation Equipment (ED) document 250 (ED-250), FAA advisory circular AC25-32, and the like. In this regard, the precise details for how to calculate the relative landing and/or stopping distances and the respective locations of the different reference points are not germane to this disclosure, and the subject matter described herein is not limited to any particular technique or algorithm to be employed by the ROAAS 142, 310 when using NOTAM-derived values for the runway condition to determine the location of a reference point associated with a runway for purposes of providing potential runway overrun alerts based the current, real-time aircraft status information.

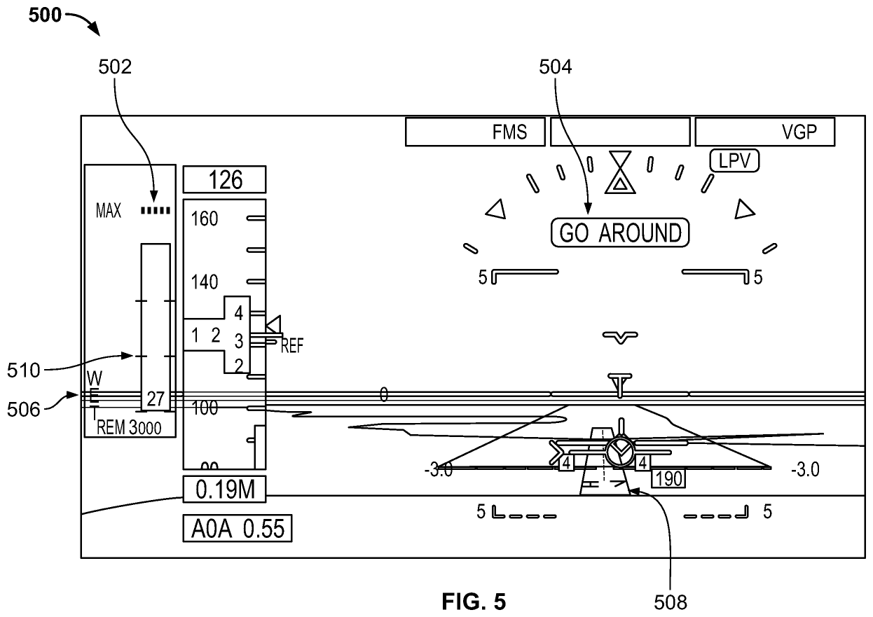

FIG. 5 depicts an exemplary flight deck GUI display 500 suitable for presentation on a display device 108, 312 associated with an aircraft including graphical indicia 502, 504, 506 that may be generated or otherwise provided by a ROAAS 142, 310 based on NOTAM-derived values for a surface condition associated with a destination runway for the aircraft. The GUI display 500 depicted in FIG. 5 includes or is otherwise realized as a primary flight display capable of being utilized by a pilot or other user for guidance with respect to manually flying the aircraft, that is, the pilot's primary reference for flight information (e.g., speed and altitude indicia, attitude indicia, lateral and vertical deviation indicia, mode annunciations, and the like). It should be appreciated that flight deck GUI display 500 depicted in FIG. 5 represents the state of a dynamic display frozen at one particular time, and that the flight deck GUI display 500 may be continuously refreshed during operation as the aircraft travels to reflect changes in the attitude, altitude and/or position of the aircraft with respect to the Earth. In various implementations, a primary flight display may include any number of different features that are graphically rendered, including, without limitation a synthetic perspective view of terrain, a reference symbol corresponding to the current flight path of the aircraft, an airspeed indicator (or airspeed tape) that indicates the current airspeed of the aircraft, an altitude indicator (or altimeter tape) that indicates the current altitude of the aircraft, a zero pitch reference line, a pitch ladder scale, a compass, and an aircraft reference symbol. In this regard, the embodiment shown in FIG. 5 has been simplified for ease of description and clarity of illustration—in practice, embodiments of the primary flight display may also contain additional graphical elements corresponding to or representing pilot guidance elements, waypoint markers, flight plan indicia, flight data, numerical information, trend data, and the like. For the sake of clarity, simplicity, and brevity, the various graphical elements of the primary flight display will not be described herein.

The illustrated flight deck GUI display 500 depicted in FIG. 5 includes a graphical representation of a destination runway 508 (e.g., a runway outline) that the aircraft is en route to. In this regard, the runway indicator 508 is depicted with respect to the terrain in a manner that reflects the altitude of the runway and the orientation of the runway heading with respect to the surrounding terrain. The depicted terrain is based on a set of terrain data that corresponds to a viewing region proximate the current location of aircraft that corresponds to the forward-looking cockpit viewpoint from the aircraft and is rendered in accordance with navigational information (e.g., latitude, longitude, and altitude) and orientation information (e.g., aircraft pitch, roll, heading, and yaw) associated with the aircraft obtained from one or more onboard avionics systems. As shown, the terrain may be rendered in a perspective or three dimensional view that corresponds to a flight deck (or cockpit) viewpoint that simulates the vantage point of a person in the cockpit of the aircraft (e.g., a line of sight aligned with a longitudinal axis of the aircraft). In this regard, FIG. 5 depicts a forward-looking cockpit view for an aircraft on approach to the destination runway 508.

FIG. 5 depicts a scenario where a NOTAM message indicates a wet runway surface condition (e.g., runway condition code value of 5) that, when incorporated or otherwise imported into the ROAAS 142, 310 results in the ROAAS 142, 310 and/or the potential runway overrun alerting module 148 calculating, based on the current aircraft energy state and the wet runway surface condition, an estimated location for the exit point that extends beyond the available runway length indicative of a potential runway overrun condition. The ROAAS 142, 310 generates or otherwise provides a graphical representation of the estimated location of the exit point 502 at a relative location with respect to a graphical representation of the runway 510 that reflects the estimated stopping distance between the location of the runway threshold and the location of the exit point 502 within a region of the GUI display 500 that is associated with graphics generated by the ROAAS 142, 310. When the exit point extends beyond the end of the runway (or the currently available runway length) indicative of a potential runway overrun condition, the ROAAS 142, 310 may render the graphical indicia 502, 510 associated with the ROAAS 142, 310 using a visually distinguishable graphical characteristic (e.g., a red color) that indicates that there is insufficient available runway length for landing the aircraft on the runway. In the illustrated embodiment, the ROAAS 142, 310 also generates or otherwise provides a graphical representation of the runway surface condition 506 derived from the NOTAM message. Additionally, when the exit point extends beyond the end of the runway (or the currently available runway length), the ROAAS 142, 310 may generate or otherwise provide a graphical user notification 504 at a prominent location within the GUI display 500 to alert the pilot or other aircraft operator of the potential runway overrun condition.

For the sake of brevity, conventional techniques related to user interfaces, avionics systems, TOLD calculations and systems, ROAAS and other runway alerting systems, NOTAMs, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

The subject matter may be described herein in terms of functional and/or logical block components, and with reference to symbolic representations of operations, processing tasks, and functions that may be performed by various computing components or devices. It should be appreciated that the various block components shown in the figures may be realized by any number of hardware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices. Furthermore, embodiments of the subject matter described herein can be stored on, encoded on, or otherwise embodied by any suitable non-transitory computer-readable medium as computer-executable instructions or data stored thereon that, when executed (e.g., by a processing system), facilitate the processes described above.

The foregoing description refers to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically. Thus, although the drawings may depict one exemplary arrangement of elements directly connected to one another, additional intervening elements, devices, features, or components may be present in an embodiment of the depicted subject matter. In addition, certain terminology may also be used herein for the purpose of reference only, and thus are not intended to be limiting.

The foregoing detailed description is merely exemplary in nature and is not intended to limit the subject matter of the application and uses thereof. Furthermore, there is no intention to be bound by any theory presented in the preceding background, brief summary, or the detailed description.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the subject matter in any way. Rather, the foregoing detailed description will provide those skilled in the art with a convenient road map for implementing an exemplary embodiment of the subject matter. It should be understood that various changes may be made in the function and arrangement of elements described in an exemplary embodiment without departing from the scope of the subject matter as set forth in the appended claims. Accordingly, details of the exemplary embodiments or other limitations described above should not be read into the claims absent a clear intention to the contrary.

What is claimed is:

1. A method of assisting operation of an aircraft, the method comprising:
obtaining a first set of one or more attributes associated with a runway from a first data source onboard the aircraft;
obtaining status information associated with the aircraft from a second data source onboard the aircraft;
obtaining, over a network, a message relevant to the runway from an external data source;
analyzing the message to automatically identify a second set of one or more attributes associated with a condition of the runway;
determining a location of a reference point associated with the runway based at least in part on the status information using the first set of one or more attributes in a manner that is influenced by the second set of one or more attributes from the message; and
providing, on a display device associated with the aircraft, an indication influenced by the location of the reference point.

2. The method of claim 1, wherein obtaining the first set of one or more attributes comprises obtaining one or more current values for the one or more attributes associated with the runway from at least one of a flight management system (FMS) and a runway overrun awareness and alerting system (ROAAS).

3. The method of claim 2, further comprising automatically configuring the at least one of the FMS and the ROAAS to utilize a specified value for a runway surface condition attribute from the second set of one or more attributes when an existing value for the runway surface condition attribute is missing from the one or more current values for the one or more attributes, wherein:
determining the location comprises the at least one of the FMS and the ROAAS determining the location of the reference point using the specified value for the runway surface condition attribute.

4. The method of claim 2, further comprising automatically configuring the at least one of the FMS and the ROAAS to utilize a specified value for a runway surface condition attribute from the second set of one or more attributes when an existing value for the runway surface condition attribute of the one or more current values for the one or more attributes is invalid, wherein:
determining the location comprises the at least one of the FMS and the ROAAS determining the location of the reference point using the specified value for the runway surface condition attribute.

5. The method of claim 2, wherein the message comprises a notice to airmen (NOTAM).

6. The method of claim 1, further comprising determining the first set of one or more attributes does not include the condition of the runway prior to determining the location of the reference point using the second set of one or more attributes from the message.

7. The method of claim 1, further comprising determining the first set of one or more attributes includes an invalid value for the condition of the runway prior to determining the location of the reference point using the second set of one or more attributes from the message.

8. The method of claim 1, further comprising providing a user notification on the display device associated with the aircraft when a first value for the condition from the first set of one or more attributes obtained from the first data source onboard the aircraft is different from a second value for the condition of the runway identified from the message.

9. The method of claim 8, further comprising receiving a user indication to utilize the second value for the condition of the runway prior to determining the location of the reference point using the second value for the condition of the runway.

10. The method of claim 1, wherein:
the message comprises a notice to airmen (NOTAM);
analyzing the message comprises analyzing the NOTAM to automatically identify a surface condition associated with at least a portion of the runway; and
the location of the reference point is influenced by the surface condition.

11. The method of claim 10, wherein the indication comprises a graphical indication the location of the reference point.

12. The method of claim 11, wherein the reference point an exit point for rollout to taxi from the runway.

13. An aircraft system comprising:
a display device;
a communications interface to receive, from an external data source, a message relevant to a runway associated with a flight plan for an aircraft; and
a controller coupled to the display device and the communications interface to:
obtain a first set of one or more attributes associated with the runway from a first data source onboard the aircraft;
analyze the message to automatically identify a second set of one or more attributes associated with a condition of the runway;
obtain status information associated with the aircraft from a second data source onboard the aircraft;
determine a location of a reference point associated with the runway based at least in part on the status information using the first set of one or more attributes in a manner that is influenced by the second set of one or more attributes from the message; and
provide, on the display device, an indication influenced by the location of the reference point.

14. The aircraft system of claim 13, wherein the first data source comprises a flight management system (FMS) coupled to the controller to perform a takeoff and landing data (TOLD) calculation for the runway based at least in part on the status information using the first set of one or more attributes in a manner that is influenced by the second set of one or more attributes from the message, wherein the indication is influenced by a result of the TOLD calculation.

15. The aircraft system of claim 13, wherein:
the first data source comprises a runway overrun awareness and alerting system (ROAAS) coupled to the controller;
the indication comprises a potential runway overrun alert;
the location of the reference point comprises an estimated location of an exit point utilized by the ROAAS to determine whether to generate the potential runway overrun alert for the runway; and
the ROAAS calculates the estimated location of the exit point based at least in part on the status information using the first set of one or more attributes in a manner that is influenced by the second set of one or more attributes from the message.

16. The aircraft system of claim 13, wherein:
the message comprises a notice to airmen (NOTAM) including a runway condition code associated with at least a portion of the runway; and
the location for the reference point is calculated based at least in part on the status information using the runway condition code.

17. At least one computer-readable medium having computer-executable instructions stored thereon that, when executed by at least one processing system, cause the at least one processing system to:
obtain a first set of one or more attributes associated with a runway from a first data source onboard an aircraft;
obtain status information associated with the aircraft from a second data source onboard the aircraft;
obtain, over a network, a message relevant to the runway from an external data source;
analyze the message to automatically identify a second set of one or more attributes associated with a condition of the runway;
determine a location of a reference point associated with the runway based at least in part on the status information using the first set of one or more attributes in a manner that is influenced by the second set of one or more attributes from the message; and
provide, on a display device associated with the aircraft, an indication influenced by the location of the reference point.

18. The at least one computer-readable medium of claim 17, the first set of one or more attributes comprising one or more current values for the one or more attributes associated with the runway obtained from at least one of a flight management system (FMS) and a runway overrun awareness and alerting system (ROAAS), wherein:
the computer-executable instructions cause the at least one processing system to automatically configure the at least one of the FMS and the ROAAS to utilize a specified value for a runway surface condition attribute from the second set of one or more attributes when an existing value for the runway surface condition attribute is invalid or missing from the one or more current values for the one or more attributes; and
the at least one of the FMS and the ROAAS determines the location of the reference point using the specified value for the runway surface condition attribute.

19. The at least one computer-readable medium of claim 17, wherein:
the message comprises a notice to airmen (NOTAM) including a specified value for a runway condition code indicative of a surface condition for at least a portion of the runway; and
the location of the reference point comprises an estimated location of an exit point determined based at least in part on the specified value for the runway condition code indicative of the surface condition.

20. The at least one computer-readable medium of claim 17, wherein the computer-executable instructions cause the at least one processing system to provide a user notification on the display device associated with the aircraft when a first value for the condition from the first set of one or more attributes obtained from the first data source onboard the aircraft is different from a second value for the condition of the runway identified from the message.
